(19) United States
(12) Patent Application Publication
(10) Pub. No.: US 2008/0087179 A1
(43) Pub. Date: Apr. 17, 2008

(54) Printing couple of a printing press

(75) Inventors: Thomas John, Augsburg (DE); Thomas Kandlbinder, Augsburg (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG

(21) Appl. No.: 11/904,665

(22) Filed: Sep. 28, 2007

(30) Foreign Application Priority Data
Sep. 29, 2006 (DE) 10 2006 046 521.0

(51) Int. Cl. B41F 7/04

(52) U.S. Cl. 101/217

(57) ABSTRACT

A printing couple of a printing press, such as a rotary printing press, where the printing couple includes a form cylinder, a transfer cylinder, an impression cylinder, and an inking couple. Here, the inking couple can apply the printing ink to the form cylinder, that is, to the printing forms which are positioned on the form cylinder. The transfer cylinder, which carries at least one blanket or rubber sleeve positioned on it, transfers the printing ink to a substrate. The ink is transported through a printing gap formed between the transfer cylinder and the impression cylinder. The diameter of at least one cylinder, such the form cylinder, the transfer cylinder and the impression cylinder, is graduated in the axial direction.

### BACKGROUND OF THE INVENTION

1. Field of the Invention

The present invention generally relates to the field of printing presses and, more particularly, to a printing couple of a printing press.

2. Description of the Related Art

Printing couples of printing presses have a form cylinder, a transfer cylinder rolling on the form cylinder, an impression cylinder rolling on the transfer cylinder, an inking couple, and possibly a dampening unit. By means of the inking couple, the printing ink can be applied to the form cylinder, namely, to at least one printing form positioned on the form cylinder. The form cylinder is also referred to as a plate cylinder. The transfer cylinder, which carries at least one blanket or rubber sleeve positioned on it, transfers the printing ink to the substrate, where the substrate can be moved through a printing gap formed between the transfer cylinder and the impression cylinder. The transfer cylinder is also called the blanket cylinder. In the case of rotary printing presses, several printing couples are usually combined into a printing unit; in this case, the impression cylinder of a printing couple of a printing unit either rolls as a so-called “satellite” cylinder on several transfer cylinders of different printing couples of the printing unit or is configured as a transfer cylinder of a different printing couple of the printing unit.

To ensure the proper transfer of ink in the printing couple, a defined pressure is required between the form cylinder and the transfer cylinder and also between the transfer cylinder and the impression cylinder.

As a result of deflections of the cylinders during the operation of the printing couple, the pressure between the cylinders can vary in the axial direction, so that the ink is not transferred uniformly along the width or axial dimension of the cylinders. As a result, print quality is negatively affected. In particular, this type of non-uniform ink transfer caused by deflections of the cylinders as they roll over each other is evident when the cylinders are relatively slender, i.e., cylinders which are relatively long in the axial direction and have a relatively small diameter.

It is therefore apparent there is need to create a printing couple of a printing press that solves the foregoing problems.

### SUMMARY OF THE INVENTION

This and other objects and advantages are achieved in the present invention by providing a spindle drive that can be rotatably driven by two or more series-connected electric motors. In accordance with the invention, the diameter of at least one cylinder, i.e., at least one of the form cylinder, the transfer cylinder and the impression cylinder, is graduated in the axial direction.

The foregoing and other problems are solved by a printing couple of a printing press that comprises a form cylinder, a transfer cylinder rolling on the form cylinder, an impression cylinder rolling on the transfer cylinder, and an inking couple operable to transfer printing ink to the form cylinder. The transfer cylinder carries at least one blanket or rubber sleeve positioned on the transfer cylinder, transfers the printing ink to a substrate, where the ink is transported through a printing gap formed between the transfer cylinder and the impression cylinder, and the diameter of at least one of the form cylinder, the transfer cylinder and the impression cylinder is graduated in the axial direction

In accordance with the invention, deflections of the cylinders of a printing couple are compensated for by graduating the diameter of at least one cylinder in the axial direction, i.e., across its width. As a result, especially in the case of slender cylinders, it becomes particularly possible to counteract the non-uniform transfer of ink caused by the deflection of such slender cylinders. Print quality can thus be improved.

Generally, the at least one of form cylinder, the transfer cylinder and the impression cylinder can have a diameter that is graduated in the axial direction. However, it is preferable for only the impression cylinder to be provided with a diameter which is graduated in the axial direction.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The various features, functions and advantages characterizing the invention will be better understood by reference to the detailed description which follows, taken in conjunction with the accompanying drawing. It should be understood that the drawing is not necessarily drawn to scale and that, unless otherwise indicated, it is merely intended to conceptually illustrate the structures and procedures described herein.

FIG. 1 shows a schematic diagram of a transfer cylinder of a printing couple in accordance with an exemplary embodiment of the invention;

FIG. 2 shows a schematic diagram of a transfer cylinder of a printing couple in accordance with another exemplary embodiment of the invention;

FIG. 3 shows a schematic diagram of an impression cylinder of a printing couple in accordance with a further exemplary embodiment of the invention;

FIG. 4 shows an arrangement of the form cylinder, a transfer cylinder, an impression cylinder in accordance with the exemplary embodiments of the invention; and

FIG. 5 shows a schematic diagram of an intermediate element arranged in accordance with an embodiment of the invention.

### DETAILED DESCRIPTION OF THE PRESENTLY PREFERRED EMBODIMENTS

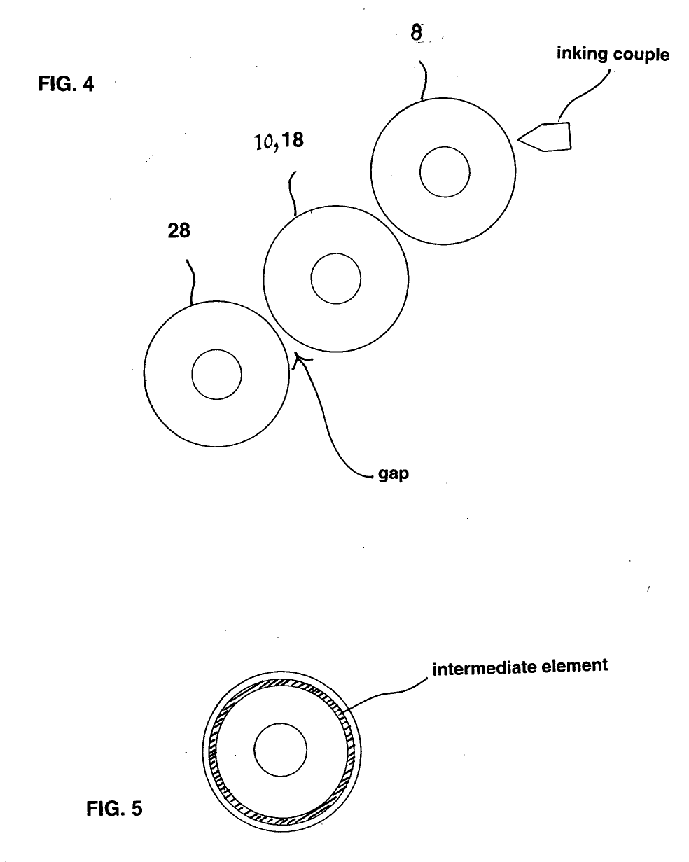

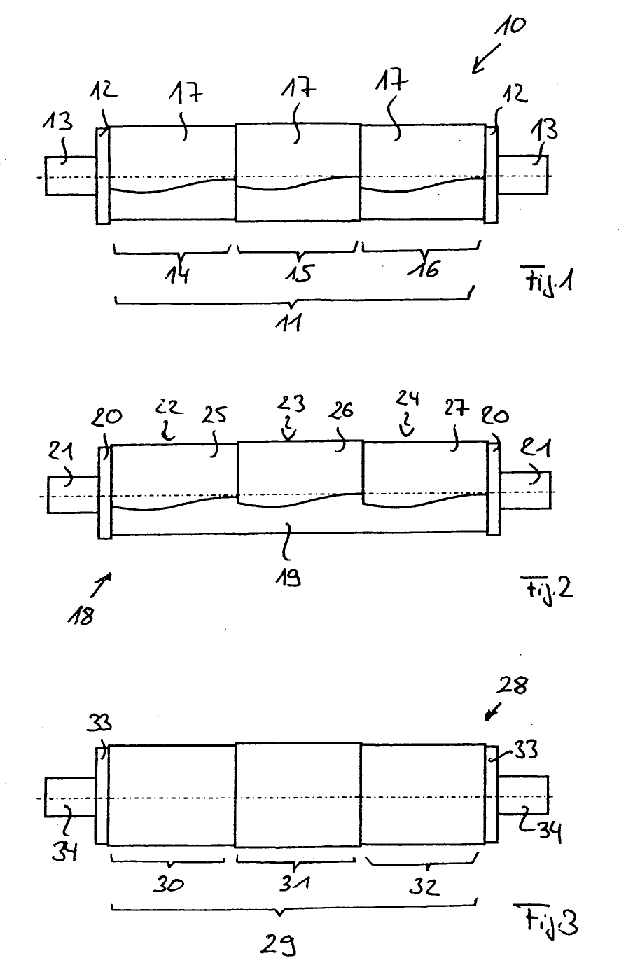

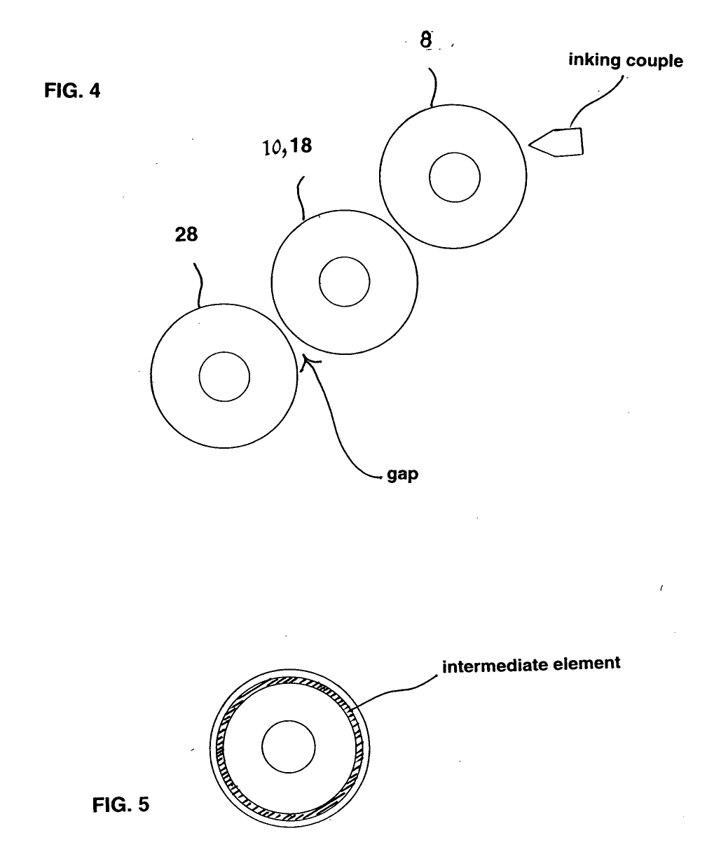

The present invention relates to a printing couple of a printing press, such as a rotary printing press, where the printing couple has a form cylinder 8, a transfer cylinder 10, 18, an impression cylinder 28, an inking couple, and preferably a dampening unit (see FIG. 4). The inking couple is used to apply printing ink to the form cylinder 8 or plate cylinder, i.e., to the printing forms which are positioned on the form cylinder.

The blanket or rubber sleeve, at least one of which is present on the transfer cylinder or blanket cylinder, transfers the ink to the substrate to be printed, which is transported through a gap formed between the transfer cylinder or blanket cylinder and the impression cylinder.

In contemplated embodiments, several printing couples are combined into a printing unit. Here, the impression cylinder of the printing couple of a printing unit is either a satellite cylinder rolling on several transfer cylinders of different printing couples or a transfer cylinder of a different printing couple of the printing unit.

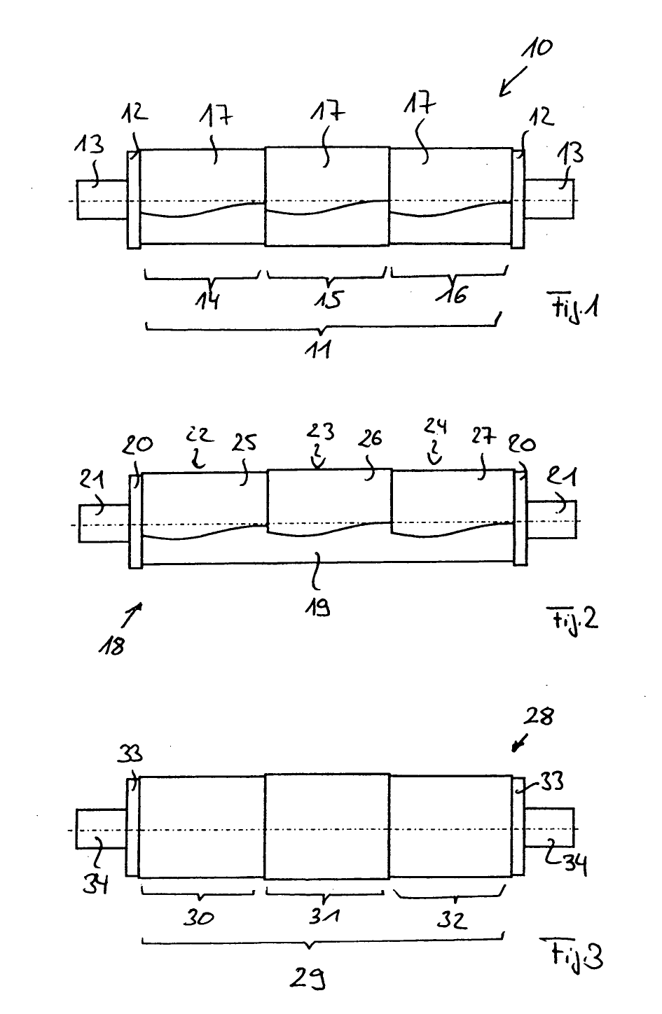

FIG. 1 shows a schematic illustration of a transfer cylinder or blanket cylinder 10 of a printing couple of a printing press in accordance with an exemplary embodiment of the invention. The transfer cylinder 10 includes a cylinder base body 11 with a bearer ring 12 and a shaft journal 13 at each end. The bearer rings 12 are used to adjust the nominal size of the transfer cylinder 10, and the shaft journals 13 are used to support the cylinder rotatably in a machine stand.

In the exemplary embodiment shown in FIG. 1, the diameter of the cylinder base body 11 is graduated in the axial direction. In the exemplary embodiment shown in FIG. 1, the cylinder base body 11 is divided in the axial direction into three segments 14, 15, 16 such that the middle segment 15 has a larger diameter than the lateral segments 14 and 16.

Blankets 17, each of which have identical thicknesses, are arranged on the segments 14, 15, and 16 of the cylinder base body 11 of the transfer cylinder 10. As deriveable from FIG. 1, the outside diameter of the segments 14, 15, and 16 of the cylinder base body 11 are slightly smaller than the outside diameter of the bearer rings 1. However, after positioning the blankets 17 on the segments 14, 15, 16, the transfer cylinder 10 will have an outside diameter in the area of the segments 14, 15, 16 that is slightly larger than that of the bearer rings 12.

In the preferred embodiment, only the transfer cylinder 10 of a printing couple is configured in the manner shown in FIG. 1. Alternatively, however, it is also possible, in addition to the transfer cylinder or alternatively to the transfer cylinder, to configure at least one of the form cylinder and the impression cylinder in the manner shown in FIG. 1, so that these cylinders will have several segments of different diameters adjacent to each other in the axial direction.

FIG. 2 shows a transfer cylinder 18 of a printing couple of a printing press in accordance with another exemplary embodiment of the invention, where the transfer cylinder 18 of FIG. 2, similarly to the transfer cylinder 10 of the embodiment shown in FIG. 1, has a cylinder base body 19 with a bearer ring 20 and a shaft journal 21 at each end.

With specific reference to FIG. 2, the cylinder base body 19 of the transfer cylinder 18 has a uniform diameter over the entire axial dimension. In accordance with the embodiment shown in FIG. 2, this diameter is smaller than the diameter of the bearer rings 20. Blankets 25, 26, 27, each of which have different thicknesses, are arranged on the various axial sections 22, 23, 24 of the cylinder base body 19 having the uniform diameter. In accordance with the exemplary embodiment shown in FIG. 2, for example, the blanket 26 on the middle axial section 23 has a greater thickness than the blankets 25 and 27 on the lateral axial sections 22 and 24.

A feature that is common to both exemplary embodiments, i.e., those shown in FIGS. 1 and 2, is that the transfer cylinder 10, 18, i.e., the circumference of its cylinder base body 11, 19, carries or includes blankets 17, 25, 26, 27 and that the diameter is graduated in the axial direction.

In both of these contemplated embodiments, the diameter of a middle segment 15 or of a middle axial section 23 is larger than that in the area of the lateral segments 14, 16 or of the lateral axial sections 22, 24 to compensate for the deflection of the cylinder and to ensure that pressure is exerted uniformly along the entire axial dimension of the cylinder and, thus, ensure that the ink is transferred uniformly.

In contrast to the exemplary embodiments of FIGS. 1 and 2, in another contemplated embodiment, a transfer cylinder with a diameter graduated in the axial direction is provided by using a cylinder base body having a uniform diameter in the axial direction and blankets having uniform thicknesses that are positioned on the cylinder base body. In addition, an intermediate element is arranged at least between the middle axial section of the cylinder base body and the blanket or each blanket to be positioned on the middle axial section, so that the diameter of the transfer cylinder is again larger in the middle axial section than in the lateral axial sections. This intermediate element is preferably an underpacking foil (see FIG. 5), which is bonded either to the cylinder base body in the middle axial section or to the blanket in question. Even though the underpacking is not shown in the drawings, the underpacking being located underneath the location of the middle axial section should be readily apparent to the skilled person.

It is also possible to combine the above-described measures with each other; that is, the diameter of the cylinder base body can be graduated in the axial direction, blankets of different thicknesses can be positioned in the area of the individual segments, and it is also possibly to use intermediate elements between the corresponding segments and the blankets.

The contemplated embodiments described with reference to FIGS. 1 and 2 are preferred exemplary embodiments of a printing couple, where the transfer cylinder has a diameter graduated in the axial direction in the manner previously specified. Moreover, as previously described, the form cylinder of the printing couple can also be configured in the manner described above but with printing plates, as opposed to blankets, that are positioned on the cylinder base body.

In an alternative embodiment, an impression cylinder is configured in the same manner as previously described with respect to transfer cylinders. FIG. 3 shows an impression cylinder 28 of a printing couple in accordance with the contemplated embodiment, the diameter of which is graduated in the axial direction. In the exemplary embodiment shown in FIG. 3, the impression cylinder 28 has a cylinder base body 29 that is divided in the axial direction into three segments 30, 31, 32 with different diameters such that that the middle segment 31 has a larger diameter than the two lateral segments 30 and 32. A bearer ring 33 and a shaft journal 34 are again present at each end of the cylinder.

It should be noted that that the differences in the diameters of the cylinders are in the range of a few hundredths of a millimeter. However, diameter differences on this scale are sufficient to compensate for deflections of the cylinders during their operation.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A printing couple of a printing press, comprising:
a form cylinder;
a transfer cylinder rolling on the form cylinder;
an impression cylinder rolling on the transfer cylinder; and
an inking couple operable to transfer printing ink to the form cylinder;
wherein the transfer cylinder includes at least one blanket or rubber sleeve positioned on the transfer cylinder, transfers the printing ink to a substrate, said ink being transported through a printing gap formed between the transfer cylinder and the impression cylinder; and
wherein a diameter of at least one of the form cylinder, the transfer cylinder and the impression cylinder is graduated in the axial direction.

2. The printing couple according to claim 1, wherein only the transfer cylinder has a diameter which is graduated in the axial direction.

3. The printing couple according to claim 1, wherein the at least one cylinder having a diameter graduated in the axial direction has a cylinder base body which is divided in the axial direction into several segments having different diameters.

4. The printing couple according to claim 3, wherein the cylinder base body is divided into three segments, where a middle segment has a larger diameter than lateral segments.

5. The printing couple according to claim 1, wherein the diameter of the transfer cylinder is graduated in the axial direction, the transfer cylinder having a cylinder base body with a diameter which is uniform in the axial direction, and blankets or rubber sleeves arranged on respective axial sections of the cylinder, at least one of the blankets or rubber sleeves having a different thickness than the others of the blankets or rubber sleeves.

6. The printing couple according to claim 5, wherein the at least one blanket or rubber sleeve arranged on a middle axial section of the cylinder base body has a greater thickness than the blankets or rubber sleeves arranged on lateral axial sections of the cylinder base body.

7. The printing couple according to claim 1, wherein the at least one cylinder having the diameter graduated in the axial direction has a cylinder base body with a diameter which is uniform in the axial direction;
wherein blankets or rubber sleeves arranged on the cylinder base body in different axial sections of the cylinder have a uniform thickness; and
wherein at least one intermediate element is arranged at least between the blanket or rubber sleeve on a middle axial section of the cylinder base body and the middle axial section, so that the diameter of the at least one cylinder is larger in the middle axial section than in lateral axial sections.

8. The printing couple according to claim 7, wherein the intermediate element or each intermediate element is configured as underpacking foil, which is bonded to one of the cylinder base body and the at least one blanket or rubber sleeve.

9. The printing couple according to claim 1, wherein the transfer cylinder having a diameter graduated in the axial direction has at least one of a cylinder base body which is divided in the axial direction into several segments of different diameters and at least one of blankets or rubber sleeves arranged on the cylinder base body in different axial sections have different thicknesses; and
wherein at least one intermediate element is arranged at least between the blanket or rubber sleeve on a middle axial section of the cylinder base body and the middle axial section.

10. The printing couple according to claim 1, wherein the printing press is a rotary printing press.

11. The printing couple according to claim 1, wherein the from cylinder comprises at least one printing form positioned on the form cylinder.

12. The printing couple according to claim 2, wherein the transfer cylinder having the diameter which is graduated in the axial direction has a cylinder base body which is divided in the axial direction into several segments having different diameters.

13. The printing couple according to claim 2, wherein the transfer cylinder having a diameter graduated in the axial direction has a cylinder base body with a diameter which is uniform in the axial direction, and wherein blankets or rubber sleeves arranged on different axial sections of the cylinder have different thicknesses.

14. The printing couple according to claim 2, wherein the transfer cylinder having the diameter graduated in the axial direction has a cylinder base body with a diameter which is uniform in the axial direction;
wherein blankets or rubber sleeves arranged on the cylinder base body in different axial sections of the cylinder have a uniform thickness; and
wherein at least one intermediate element is arranged at least between the rubber blanket or rubber sleeve on a middle axial section of the cylinder base body and the middle axial section, so that the diameter of the at least one cylinder is larger in the middle axial section than in lateral axial sections.

15. The printing couple according to claim 2, wherein the transfer cylinder having a diameter graduated in the axial direction has at least one of a cylinder base body which is divided in the axial direction into several segments of different diameters and at least one of blankets or rubber sleeves arranged on the cylinder base body in different axial sections have different thicknesses; and
wherein at least one intermediate element is arranged at least between the blanket or rubber sleeve on a middle axial section of the cylinder base body and the middle axial section.
